(19) United States
(12) Patent Application Publication
(10) Pub. No.: US 2015/0378784 A1
(43) Pub. Date: Dec. 31, 2015

(54) WORK FLOW LEVEL JOB INPUT/OUTPUT

(71) Applicant: International Business Machines Corporation, Armonk, NY (US)

(72) Inventors: Kinson Chik, Markham (CA); Meng Ding, Markham (CA); Qingda Wang, Richmond Hill (CA)

(21) Appl. No.: 14/316,975

(22) Filed: Jun. 27, 2014

(51) Int. Cl. G06F 9/48; G06F 17/30

(52) U.S. Cl. CPC G06F 9/4881; G06F 17/30165

(57) ABSTRACT

Work flows consist of the following steps: (i) receiving a work flow data set that defines a work flow which includes a plurality of work items; and (ii) defining, a centralized and pattern-based work flow level job input/output (I/O) characteristic set that includes at least I/O settings for work items included in the work flow.

### STATEMENT ON PRIOR DISCLOSURES BY INVENTOR

The following disclosure(s) are submitted under 35 U.S.C. 102(b)(1)(A) as prior disclosures by, or on behalf of, a sole inventor of the present application or a joint inventor of the present application:

(i) IBM, “Announcing IBM Platform LSF, PAC, PPM, RTM and LS V9.1.2, Dec. 13, 2013, GA date for Grace Period Disclosure, <https://www.ibm.com/developerworks/community/forums/html/topic?id=c36a876f-b709-404e-9f38-30652a02ab38>.

### BACKGROUND OF THE INVENTION

The present invention relates generally to the field of work flow automation software and more particularly to the customization of dynamic I/O settings to be applied on a logical grouping of work items.

Work flow is a coordinated and repeatable pattern of activity, enabled by organizing resources into processes that can convert or change materials, provide services, or process information. Work flow can be described as the work performed by a person, a group or an organization. Work flow may also be described as a series or sequence of operations and/or a simple or complex mechanism. Work flow may also be viewed as a representation of real work, thus serving as a virtual representation of actual work being performed. The description of work flow may be a reference to a document, service, or product that is being moved from one step to another. Work flow may also be regarded as a fundamental building block of an organizations' structure.

Work flow automation software is used to group and create relationships between batch jobs or local processes which are processed in an automated fashion. When defining a work flow, users are able to specify I/O (input/output) at the job level. This needs to be done per job for current work flow automation systems. Work flows typically represent a logical grouping of jobs designed to accomplish a single goal. With this in mind, most of the jobs can logically adhere to a customized pattern to control I/O during processing. This makes it possible to create a logical organization of input and output files.

### SUMMARY

According to an aspect of the present invention, there is a method, system and/or computer program product that performs the following steps (not necessarily in the following order): (i) receiving a work flow data set that defines a work flow which includes a plurality of work items; (ii) defining, based at least in part upon the user input data, a centralized and pattern-based work flow level job input/output (I/O) characteristic set that includes at least one I/O setting(s) for work items included in the work flow; and (iii) resolving dynamically at runtime the I/O settings to manage I/O when running the work flow any number of times.

### BRIEF DESCRIPTION OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system;

FIG. 4 is a screenshot view generated by the first embodiment system; and

FIG. 5 is a screenshot view generated by a second embodiment according to the present invention.

### DETAILED DESCRIPTION

Some embodiments of the present invention recognize a convenient method to define centralized and pattern-based I/O (input/output) settings for automation software work flow jobs or work flow subset jobs. Some embodiments of the present invention further recognize a method to create a simple framework which centralizes the I/O setting of jobs at the main work flow level or any level of the sub-work flows.

This Detailed Description section is divided into the following sub-sections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

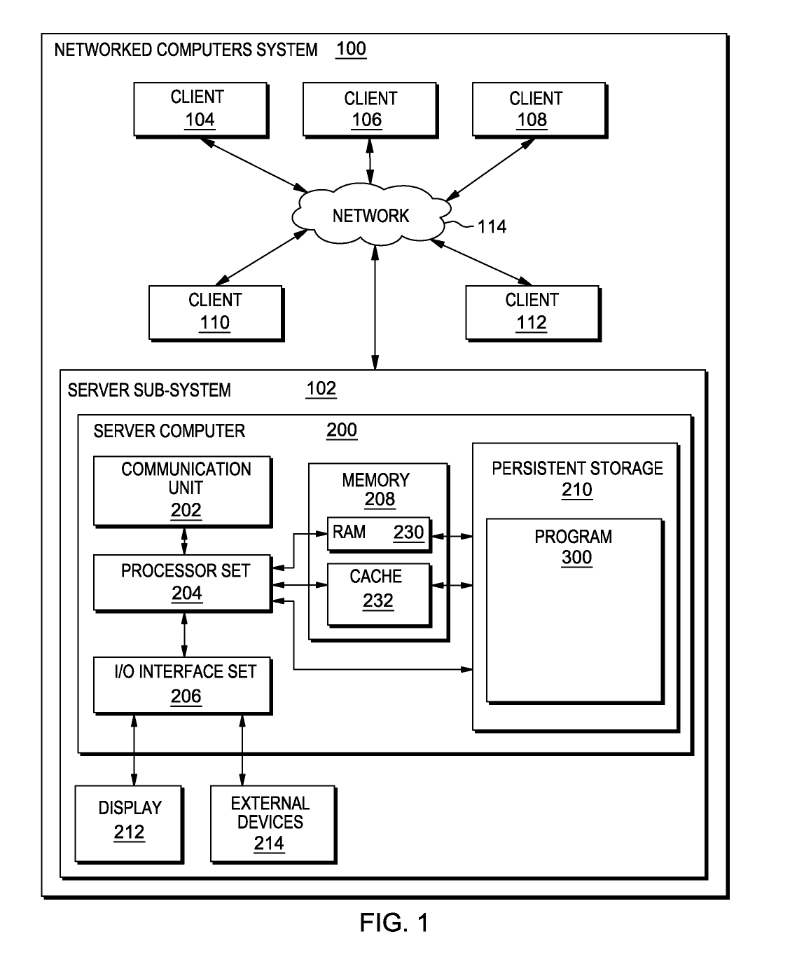

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. EXAMPLE EMBODIMENT

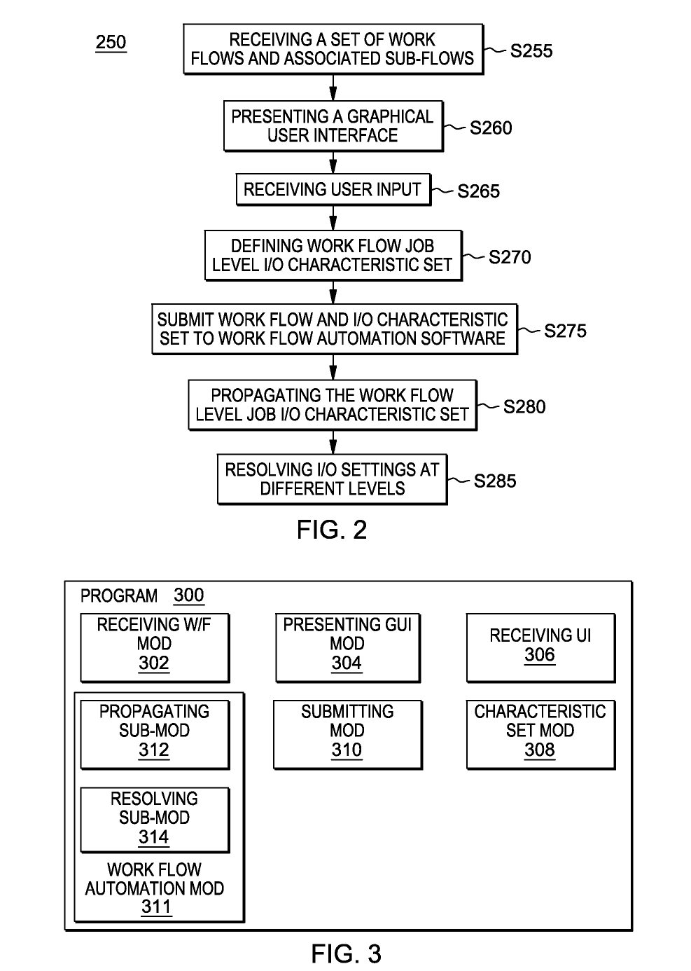

FIG. 2 shows flowchart 250 depicting a method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where receiving work flow module (“mod”) 302 receives a work flow data set which specifies a workflow. In some cases, this workflow will have been created by a human user based on business objectives. This received work flow: (i) is re-runnable (although it is not generally running at the time it is received at step S255); and (ii) includes a definition of jobs; (iii) further includes commands which the jobs will run when the workflow is run; and (iv) data used for the work flow can be anything digital accessible by the software.

Processing proceeds to step S260, where presenting GUI mod 304 presents a graphical interface on display device 212 (see FIG. 1) to a user (not shown). This GUI form includes dynamic components which are displayed and manipulated by the user. The GUI form is used to capture user input for centralized and pattern based I/O settings of work items in the work flow. In this embodiment, the GUI form also receives input on sub-work flows and/or I/O settings for sub-work flows. These sub-work flows usually represent logical sub-task(s) of an overall business objective(s) which caused the work flow to be created. Alternatively, in some embodiments of the present invention, the user input is received through a non-GUI user interface (of any type now existing or to be developed in the future), such as a command line interface.

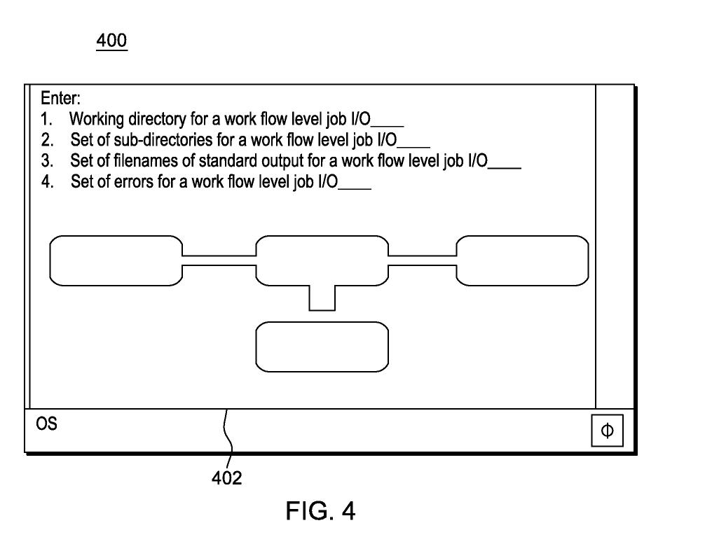

As shown in FIG. 4, screen shot 400 includes GUI window 402 which includes: (i) a workflow graphic; and (ii) a user input data portion. The GUI graphic, as shown in GUI window 402, represents the defined and static work flow received at step S255.

Processing proceeds to step S265 where receiving UI mod 306 receives user input (through external device set 214 (see FIG. 1)) and GUI interface 402. The user input received at step S265 relates to user input for centralized and pattern based I/O settings of work items in the work flow and input on sub-work flows. In this embodiment, the user's inputs are values to be directly used as the centralized and pattern based I/O settings. Alternatively, the user may input less direct input upon which the actual I/O settings are less directly based. In most, if not all, cases, the I/O settings will be based, at least in part, on business requirements and/or objectives. In this particular embodiment and as shown in screenshot 400, the user inputs four (4) pieces of information as follows: (i) a working directory for a work flow level job I/O, (ii) a set of sub-directories for a work flow level job I/O, (iii) a set of centralized and pattern-based filenames of standard output for a work flow level job I/O, and/or (iv) a set of centralized and pattern-based filenames of standard error for a work flow level job I/O. Other embodiments may ask for a subset of these four pieces of user input, and also may ask the user for additional pieces of information regarding I/O settings of work items in the work flow and input on sub-work flows. Processing proceeds to step S270, where characteristic set mod 308 defines a set of work flow job level input/output related characteristic(s) based upon the user input received at step S265. In this embodiment, the set of work flow job level input/output characteristics include the following: (i) a working directory for a centralized and pattern based work flow level job I/O, (ii) a set of sub-directories for a centralized and pattern based work flow level job I/O, (iii) a set of centralized and pattern-based filenames of standard output for a centralized and pattern based work flow level job I/O, and (iv) a set of centralized and pattern-based filenames of standard error for a work flow level job I/O.

Processing proceeds to step S275, where submitting mod 310 submits the work flow data set (received at step S255) and the work flow job level I/O characteristic set (defined at step S270) to workflow automation mod 311, which is a software engine that: (i) runs the work flow (that is, executes work items according to the logic of the defined relations between items in the work flow) after all the processing of flow chart 250 (that is, the method currently under discussion) has been performed; (ii) can schedule a work flow to be re-run; (iii) allows a human user to manually re-run a work flow; and (iv) applies the same centralized and pattern based I/O settings each time the work flow is run. In this embodiment the centralized and pattern based I/O settings are set into the definition (that is, the template) of the work flow.

Processing proceeds to step S280, where propagating sub-mod 312 of work flow automation mod 311 propagates the work flow job level I/O characteristic set (as previously defined at steps S265 and S270) so that the work flow can be run and re-run (as mentioned, above, in connection with step S275.

Processing proceeds to step S285, where resolving sub-mod 314 of work flow automation mod 311 resolves I/O settings at different levels of the work flow. More specifically, sub-mod 314 implements a pattern-based policy such that the I/O setting values can be dynamically resolved automatically (that is, without substantial human intervention). This resolution of I/O settings will be discussed in more detail, below, in the Further Comments And/Or Embodiments sub-section of this Detailed Description section. As mentioned above, after the method of flow chart 250 has been completed, the work flow can be run and re-run automatically and/or manually.

### III. FURTHER COMMENTS AND/OR EMBODIMENTS

Some embodiments of the present invention may recognize one, or more, of the following potential problems, drawbacks, or opportunities for improvement with respect to the state of the art: (i) defining work flow I/O (input/output) per job is tedious and error prone; (ii) if work flow I/Os are defined incorrectly, the output will be lost and cannot be recovered; (iii) defining the work flow I/O is arguably impossible to do when the work flows get complicated; (iv) defining the work flow I/O is arguably impossible to do when the work flows include a large number of jobs; and/or (v) currently conventional methods to define I/O settings for all jobs, or subsets of jobs, using current work flow automation software are inconvenient. Some embodiments of the present invention may further recognize that defining the I/O setting for jobs is tedious: (i) during the initial creation of the work flow; (ii) during the maintenance of the work flow; and/or (iii) when the work flow contains a large number of jobs.

Some embodiments of the present invention may include one, or more, of the following features, characteristics and/or advantages: (i) creating a simple framework which centralizes the I/O settings of jobs at the work flow level or sub-work flow level; (ii) the inheritance of I/O settings by all jobs within the work flow; (iii) establishing the I/O setting which may be selectively overridden to support exceptions; (iv) user interaction, within this framework, is exposed through a graphical user interface; and/or (v) the workflow level I/O setting is pattern-based so that it is a single setting at the work flow level, but unique for each job in the work flow. As an example, “%J” in the pattern represents the job ID (identification) for batch jobs.

Some embodiments of the present invention may further include one, or more, of the following features, characteristics and/or advantages: (i) create a GUI (graphical user interface) tool within the work flow automation software to expose customizable fields in order to tailor I/O settings; (ii) create a GUI tool within the work flow automation software to expose customizable fields in order to tailor I/O settings, within the work flow or within a sub work flow; (iii) the customizable data field syntax supports variables and patterns, that will be resolved at runtime, to create unique values for each job; and/or (iv) when I/O settings are specified at different levels, the core work flow automation engine resolves the levels by applying “overriding policy” (for example, jobs, then sub-flows, and finally main flow.)

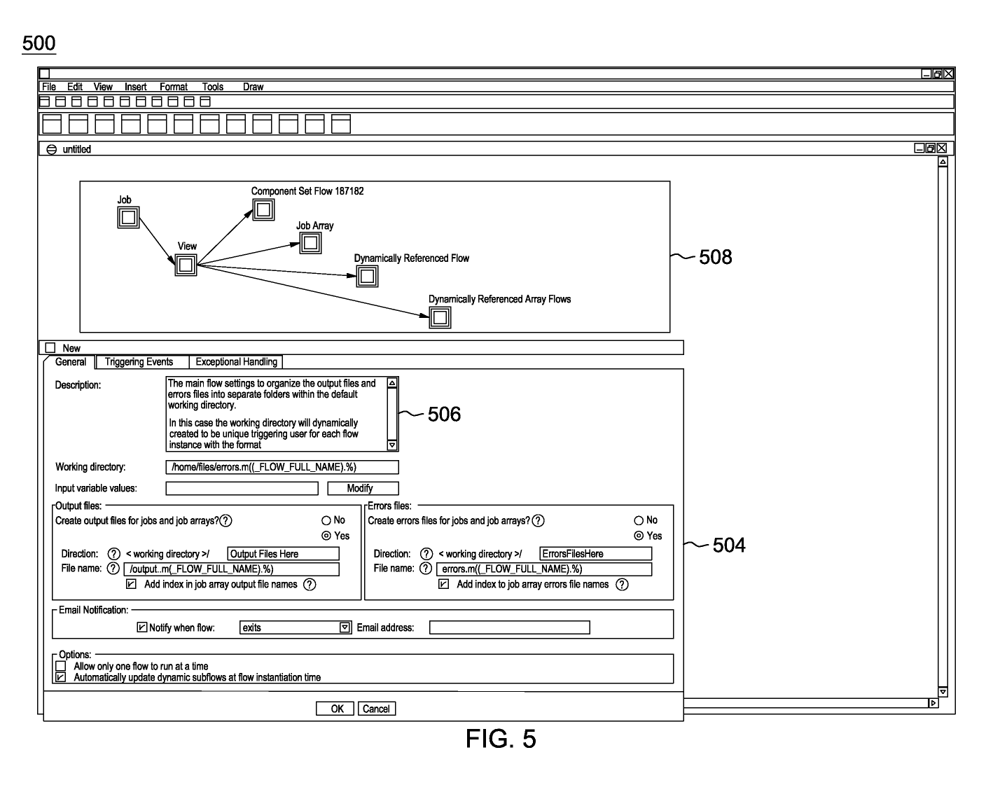

As shown in FIG. 5, screenshot 500 includes window 504 (including sub-window 506); and window 508. Window 504 presents an implemented GUI which allows users to define the working directory, sub-directories and filenames of standard output files and error files based on file patterns. It also shows an implementation example of the standard output and error streams. Sub-window 506 is a dialog for the main flow 506, which is used to propagate all settings to the sub-flows and all jobs within. The sub-flows are shown graphically in window 508.

Some embodiments of the present invention may further include one, or more, of the following features, characteristics and/or advantages with respect to features of the GUI tool: (i) ability to support pattern syntax for file names and sub-directories at a work flow level, which will be resolved at runtime; (ii) can be easily extended to support full regular expressions in the engine; (iii) can be created using a platform independent technology, such as java, to allow the tool to function on multiple platforms; (iv) uses simple data fields to specify settings individually for input, output, and errors, which are applied to the main flow and sub-flows; and/or (v) can support variables to be resolved at runtime.

Further with regard to item (v) in the paragraph above, examples of variables to be resolved at runtime include but are not limited to: (i) “% t” for the timestamp of when the job executed; (ii) “% u” for the execution user; (iii) “% J” for the job ID; and/or (iv) “#{JS_FLOW_NAME}” for the name of the work flow.

Some embodiments of the present invention may further include one, or more, of the following features, characteristics and/or advantages with respect to the underlying framework for the work flow automation engine: (i) support resolving the I/O locations and names at runtime; (ii) resolve I/O for interdependent jobs within the work flow; (iii) creating files and directories in accordance to the pattern defined from the GUI tool; (iv) supports defining pattern based work directories to create unique locations for jobs to ensure I/O is not overwritten; and/or (v) all settings defined in the tool will be applied during the execution of the work flow and will adhere to “overriding policy” (for example, jobs, sub-flows and main flow.)

Some embodiments of the present invention may further include one, or more, of the following features, characteristics, advantages and/or additional considerations: (i) the output from programs executed by jobs may not use “stdout” (standard output stream), but could generate a file as output; (ii) the logic can be generalized and applied to standard I/O; and/or (iii) the logic can be generalized and applied to I/O files by using the same pattern syntax to organize the generated files.

Some embodiments of the present invention may further include one, or more, of the following features, characteristics and/or advantages: (i) addresses the issue of I/O settings at the flow level; (ii) allows pattern based customization for the I/O, and generalized I/O, to support I/O files as well as standard I/O streams; and/or (iii) allows users to view and manage the files on the native file system, as opposed to being restricted to an interface using workload automation software.

Some embodiments of the present invention may further include one, or more, of the following features, characteristics and/or advantages: (i) uses pattern based semantics (with a GUI interface) applied to multiple work items of complex work flows utilizing the support of advanced dependencies; (ii) work flow is always automated, hence the work flows always run automatically, even by different users; (iii) for each execution, the application can dynamically generate the correct I/O, since the application allows pattern based semantics for the work flow engine to resolve; (iv) displaying of the output is not effected; (v) the application is a GUI used to assist designers in configuring complex work flow I/O for logical groupings of work items; (vi) prior to flow execution, ensures that the I/O is logically organized for work item groupings, even for different users; (vii) as configured, covers general I/O for any flow state before the work flow is executed; and/or (viii) the application can be applied to input files and output files which can not be graphically viewed through a GUI.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

What is claimed is:

1. A method comprising:
receiving a work flow data set that defines a work flow which includes a plurality of work items; and
defining a centralized and pattern-based work flow level job input/output (I/O) characteristic set that includes at least one I/O setting(s) for work items included in the work flow.

2. The method of claim 1 wherein:
the work flow level job I/O characteristic set includes a definition of: (i) a working directory for a work flow level job I/O, (ii) a set of sub-directories for a work flow level job I/O, (iii) a set of centralized filename patterns of standard output for a work flow level job I/O, and/or (iv) a set of centralized filename patterns of standard error for a work flow level job I/O.

3. The method of claim 2 further comprising:
presenting a graphical user interface (GUI), with the GUI being adapted to receive user input relating to at least one of the following work flow level job I/O characteristics: (i) a working directory for a work flow level job I/O, (ii) a set of sub-directories for a work flow level job I/O, (iii) a set of filename patterns of standard output for a work flow level job I/O, and/or (iv) a set of errors for a work flow level job I/O.

4. The method of claim 2 further comprising:
submitting the work flow and the work flow level job I/O characteristic set to workflow automation software.

5. The method of claim 4 further comprising:
propagating, by the work flow automation software, the work flow level job I/O characteristic set to different levels of the work flow.

6. The method of claim 4 further comprising:
resolving, by the work flow automation software, input and output settings at different levels of the work flow following an overriding policy to yield a resolved I/O setting for each work item.

7. The method of claim 6 further comprising:
running, by the work flow automation software, the work flow using the resolved I/O setting for each work item.

8. A computer program product comprising a computer readable storage medium having stored thereon:
first program instructions programmed to receive a work flow data set that defines a work flow which includes a plurality of work items; and
second program instructions programmed to define a centralized and pattern-based work flow level job input/output (I/O) characteristic set that includes at least one I/O setting(s) for work items included in the work flow.

9. The product of claim 8 wherein:
the work flow level job I/O characteristic set includes a definition of: (i) a working directory for a work flow level job I/O, (ii) a set of sub-directories for a work flow level job I/O, (iii) a set of centralized filename patterns of standard output for a work flow level job I/O, and/or (iv) a set of centralized filename patterns of standard error for a work flow level job I/O.

10. The product of claim 9 wherein the medium has further stored thereon:
third program instructions programmed to present a graphical user interface (GUI), with the GUI being adapted to receive user input relating to at least one of the following work flow level job I/O characteristics: (i) a working directory for a work flow level job I/O, (ii) a set of sub-directories for a work flow level job I/O, (iii) a set of filename patterns of standard output for a work flow level job I/O, and/or (iv) a set of errors for a work flow level job I/O.

11. The product of claim 9 wherein the medium has further stored thereon:
third program instructions programmed to submit the work flow and the work flow level job I/O characteristic set to workflow automation software.

12. The product of claim 11 wherein the medium has further stored thereon:
fourth program instructions programmed to propagate, by the work flow automation software, the work flow level job I/O characteristic set to different levels of the work flow.

13. The product of claim 11 wherein the medium has further stored thereon:
fourth program instructions programmed to resolve, by the work flow automation software, input and output settings at different levels of the work flow following an overriding policy to yield a resolved I/O setting for each work item.

14. The product of claim 13 wherein the medium has further stored thereon:
fifth program instructions programmed to run, by the work flow automation software, the work flow using the resolved I/O setting for each work item.

15. A computer system comprising:
a processor(s) set; and
a computer readable storage medium;
wherein:
the processor set is structured, located, connected and/or programmed to run program instructions stored on the computer readable storage medium; and
the program instructions include:
first program instructions programmed to receive a work flow data set that defines a work flow which includes a plurality of work items; and
second program instructions programmed to define a centralized and pattern-based work flow level job input/output (I/O) characteristic set that includes at least one I/O setting(s) for work items included in the work flow.

16. The system of claim 15 wherein:
the work flow level job I/O characteristic set includes a definition of: (i) a working directory for a work flow level job I/O, (ii) a set of sub-directories for a work flow level job I/O, (iii) a set of centralized filename patterns of standard output for a work flow level job I/O, and/or (iv) a set of centralized filename patterns of standard error for a work flow level job I/O.

17. The system of claim 16 wherein the medium has further stored thereon:
third program instructions programmed to present a graphical user interface (GUI), with the GUI being adapted to receive user input relating to at least one of the following work flow level job I/O characteristics: (i) a working directory for a work flow level job I/O, (ii) a set of sub-directories for a work flow level job I/O, (iii) a set of filename patterns of standard output for a work flow level job I/O, and/or (iv) a set of errors for a work flow level job I/O.

18. The system of claim 16 wherein the medium has further stored thereon:
third program instructions programmed to submit the work flow and the work flow level job I/O characteristic set to workflow automation software.

19. The system of claim 18 wherein the medium has further stored thereon:
fourth program instructions programmed to propagate, by the work flow automation software, the work flow level job I/O characteristic set to different levels of the work flow.

20. The system of claim 18 wherein the medium has further stored thereon:
fourth program instructions programmed to resolve, by the work flow automation software, input and output settings at different levels of the work flow following an overriding policy to yield a resolved I/O setting for each work item.
